(19) United States
(12) Patent Application Publication
(10) Pub. No.: US 2020/0384414 A1
(43) Pub. Date: Dec. 10, 2020

(54) Reverse Osmosis Pump Incorporating Variable Rejection Piston Design

(71) Applicant: Aqua Research LLC, Albuquerque, NM (US)

(72) Inventors: Rodney E Herrington, Albuquerque, NM (US); Kevin Roderick, Albuquerque, NM (US); Nate Jones, Albuquerque, NM (US); Kendall Weingardt, Albuquerque, NM (US); Charles Call, Albuqerque, NM (US)

(21) Appl. No.: 16/603,108

(22) PCT Filed: Apr. 11, 2018
(86) PCT No.: PCT/US2018/027178

§ 371 Date: Oct. 4, 2019

Related U.S. Application Data
(60) Provisional application No. 62/484,591, filed on Apr. 12, 2017.

(51) Int. Cl. B01D 61/10; F04B 53/14; F04B 13/00; F04B 9/105; B01D 61/02; C02F 1/44

(52) U.S. Cl. CPC B01D 61/10; F04B 53/14; F04B 13/00; B01D 2313/243; B01D 61/025; C02F 1/441; F04B 9/105

(57) ABSTRACT

A fluid treatment system, for example a membrane filtration system, utilizing means to mechanically vary fluid recovery and energy recovery to optimize fluid production for a given energy input, based on the total dissolved solids concentration in the fluid feed stream.

### TECHNICAL FIELD

The present invention is directed to a pump apparatus and, particularly, to a pump apparatus for filtering or separation a liquid, for example by reverse osmosis.

### BACKGROUND ART

Filtration of liquids to remove particulates, suspended solids, dissolved solids, and ions requires energy input to force the liquid through the filtration media. While normal filtration by physical exclusion of particles from a solute can theoretically be nearly completely efficient, the minimum energy required to overcome the osmotic pressure of the solute in reverse osmosis (RO) filtration is nonzero and determined by the osmotic pressure of the solute and the volume to be filtered. Practically the energy required is even higher depending on the recovery ratio, the ratio of permeate produced to the total water treated, since the more the remaining reject water is concentrated, the higher the average osmotic pressure required to overcome increases. The higher the recovery ratio, the higher the energy required to produce a given amount of permeate.

As the flow rate of permeate through a RO membrane is proportional to the difference between the applied pressure and the osmotic pressure of the solute, higher pressures are typically used. A pressure control valve is typically used to regulate the outlet pressure. The pressure required at the pressure control valve is typically higher than the osmotic pressure required at the outlet of the membrane to produce continued flow through the membrane at the outlet. Because of this, the difference between the set pressure of the pressure control valve and the osmotic pressure of the concentrated outlet flow results in energy loss as the concentrate exits the pressure control valve. Various energy recovery systems, including rotating doors and turbine or pump systems have been developed in order to use this lost energy to pre-pressurize the incoming solvent in order that it not be wasted.

Both Wanner, Sr., et al, and Herrington, disclose hand-held reverse osmosis systems which energy recovery by transferring energy from the concentrated outlet solution to the new solute coming into the system. Both of these systems use the design of the piston/plunger which is used to pump the inlet solute through the membrane to determine both the recovery ratio and the amount of energy recovered by energy exchange. Pressurized concentrate from the outlet of the membrane is fed to the area of the pump cylinder behind the piston in order to pressurize the back side of the piston and reduce the external energy input to the pump. In each case, the ratio of the volume of the area behind the pump cylinder fully compressed to the inlet area pump cylinder with the pump fully retracted determines the rejection ratio. Since these relative volumes are fixed by the piston and cylinder geometry, the energy recovery is also fixed by the piston design.

A shortcoming of these designs is that the fixed recovery ratio and energy recovery limit the efficiency and usefulness for a device with a fixed power source, such as a human powered device, to a fixed range of solute osmotic pressure. Solute osmotic pressure lower than the design pressure will result in less pumping effort with less than optimal permeate output, while solute osmotic pressure higher than the design pressure will require more power input than a fixed source can produce.

Filtration of saline water is an important application of reverse osmosis to create drinkable water from a variety of sources. Reverse osmosis is an effective means for removing salts and other ions, and is also used for the physical exclusion of particulates and suspended solids to provide drinkable permeate water. Water used as a source to produce drinking water can range in salinity anywhere from higher than that of seawater, which has a salinity of about 3.5%, to brackish water sources, to fresh water which is physically contaminated with microorganisms, particles, or chemical compounds which it is desirable to remove. Using a fixed recovery ratio and energy recovery in a filtration system limits optimal filtration across the range of potential water sources.

### DISCLOSURE OF INVENTION

Embodiments of the present invention provide a reciprocating piston pump for use in a reverse osmosis system, comprising a chamber, a piston slidable within the chamber, and a first element that can be configured in a first configuration wherein the piston has a first cross-sectional area receiving pressure, and second configuration wherein the piston has a second cross-sectional area receiving pressure, where the second cross-sectional area is different that the first cross-sectional area.

The pump can further comprise a shaft that moves with the piston, and wherein the first element comprises a sleeve concentric with the shaft, and in the first configuration the shaft slides through the sleeve and the sleeve is not in contact with the piston, and in the second configuration the sleeve slides with the shaft and the sleeve is in contact with the piston.

The pump can further comprise a second element that can be configured in a first configuration wherein the piston has a third cross-sectional area receiving pressure, and second configuration wherein the piston has a fourth cross-sectional area receiving pressure, where the first, second, and fourth cross-sectional areas are different from each other.

The pump can further comprise a shaft mounted with the chamber and the piston such that the shaft can slide into and out of the chamber, and such that such sliding motion of the shaft corresponds to sliding motion of the piston within the chamber, wherein the shaft has a cross-sectional area that is configurable to at least two distinct values.

Embodiments of the invention provide a reciprocating piston pump for use in a reverse osmosis system, comprising a chamber element defining an interior volume; a first piston subsystem configured to slidably engage the interior volume and separate it into first and second volumes, wherein the first piston subsystem presents a first cross-sectional area to the first volume; and a second piston subsystem configured to slidably engage the interior volume and separate it into first and second volumes, wherein the second piston subsystem presents a second cross-sectional area to the first volume; wherein the first cross-sectional area is different than the second cross-sectional area.

In some embodiments, the first piston subsystem comprises a first piston, a first shaft, and a first sealing member, wherein the first sealing member is configured to sealingly mount with the chamber element, the first piston is configured to slidably engage the interior volume, and together with the first sealing member define the first volume, wherein the first shaft is configured to slide through the first sealing member and to engage the piston such that sliding motion of the first shaft imparts sliding motion of the piston relative to the chamber element, wherein the first shaft has a first shaft cross-sectional area; and wherein the second piston system comprises a second piston, a second shaft, and a second sealing member, wherein the second sealing member is configured to sealingly mount with the chamber element, the second piston is configured to slidably engage the interior volume, and together with the second sealing member define the first volume, wherein the second shaft is configured to slide through the second sealing member and to engage the piston such that sliding motion of the second shaft imparts sliding motion of the piston relative to the chamber element, wherein the second shaft has a second shaft cross-sectional area; wherein the first shaft cross-sectional area is different than the second shaft cross-sectional area.

In some emboidments, the first piston and the second piston comprise a single piston, used as the first piston in the first piston subsystem and as the second piston in the second piston subsystem.

In some embodiments, the first sealing member and the second sealing member comprise a single sealing member, used as the first sealing member in the first piston subsystem and as the second sealing member in the second piston subsystem.

In some embodiments, the piston divides the chamber into a pumping chamber portion and a driving chamber portion, and further comprising a driving chamber seal mounted with the chamber and sealing the driving chamber portion; and wherein the first element comprises a sleeve mounted extending through the driving chamber seal; and further comprising a shaft extending from the piston through sleeve; wherein in the first configuration the sleeve is engaged with the chamber, the driving chamber seal, or both, and the shaft moves within the sleeve as the piston slides within the chamber, and wherein in the second configuration the sleeve is engaged with the piston, the shaft, or both, and the sleeve moves with the piston as the piston slides within the chamber.

Embodiments of the present invention provide a system for treatment of water, comprising a frame, a reciprocating piston pump as in any of claims 1-9 mounted with the frame; a reverse osmosis element in fluid communication with the pump; and a motor drive configured to drive the pump.

Embodiments of the present invention provide a method of treating water having a first total dissolved solids and water having a second total dissolved solids, comprising providing a reverse osmosis system; providing a pump as described herein, in fluid communication with the reverse osmosis system; configuring the pump for a first recovery ratio when treating water having the first total dissolved solids; and configuring the pump for a second recovery ratio when treating water having the second total dissolved solids.

### BRIEF DESCRIPTION OF DRAWINGS

FIG. 1A is a schematic illustration of an example embodiment of the present invention having a piston shaft with a first cross-sectional area.

FIG. 1B is a schematic illustration of an example embodiment of the present invention having a piston shaft with a second cross-sectional area.

FIG. 2A is a schematic illustration of an example embodiment of the present invention having a piston shaft with a first cross-sectional area, and a sleeve through which the piston moves.

FIG. 2B is a schematic illustration of an example embodiment of the present invention having a piston shaft with a first cross-sectional area and a sleeve that moves with the piston shaft.

FIG. 3A is a schematic illustration of an example embodiment of the present invention having a piston shaft with a first cross-sectional area, and first and second sleeves through which the piston moves.

FIG. 3B is a schematic illustration of an example embodiment of the present invention having a piston shaft with a first cross-sectional area, and a first sleeve that moves with the piston, and a second sleeve through which the piston and first sleeve move.

FIG. 3C is a schematic illustration of an example embodiment of the present invention having a piston shaft with a first cross-sectional area, and first and second sleeves that move with the piston.

FIG. 4A is a schematic illustration of an example embodiment of the present invention having a piston shaft with a first cross-sectional area, and a sleeve through which the piston moves.

FIG. 4B is a schematic illustration of an example embodiment of the present invention having a piston shaft with a first cross-sectional area and a sleeve that moves with the piston shaft.

FIG. 5 is a schematic illustration of an example embodiment.

FIG. 6 is a schematic illustration of an example embodiment.

FIG. 7A and FIG. 7B are schematic illustrations of an example embodiment illustrating coupling of a sleeve to a bushing (FIG. 7A) or a piston shaft (FIG. 7B).

FIG. 8 is an illustration of an example embodiment.

### MODES FOR CARRYING OUT THE INVENTION AND INDUSTRIAL APPLICABILITY

The present invention provides a pumping apparatus with a replaceable or variable piston geometry that can be changed in order to provide recovery ratio and energy recovery in order to provide efficient reverse osmosis filtration for a variety of solute concentrations or total dissolved solids (TDS) concentrations while employing a relatively fixed output power source. The ability to efficiently filter different water sources with a single device is highly advantageous.

While the stroke and diameter of the piston used in the system will fix the volumetric flow pushed through the membrane per stroke, varying the effective diameter of the piston shaft controls the recovery ratio and energy recovery achievable within the system. By employing various different shaft-to-piston cross-sectional area ratios, a pump can be designed to pump with the same energy input while varying the recovery ratio and energy recovery. A very high rejection ratio (high volume of rejection fluid to feed solution) with consequently low energy usage can be employed for a seawater filtration application, while a moderate rejection ratio can be used for brackish water, and a very low rejection can be used to provide larger volumes of permeate of low solute concentration fluid such as fresh water, all of which operate at approximately the same energy input to the pump.

In an example embodiment of the invention, the entire piston and shaft assembly, or simply the piston shaft alone, and the accompanying seal or bushing used to seal the shaft to the pump housing, are replaced in order to change the ratio of the shaft to piston cross sectional area. A larger shaft diameter will result in a lower rejection ratio, while a smaller shaft diameter will result in a higher rejection ratio. The maximum rejection ratio is limited by the physical strength of the shaft needed to drive the piston while pressurizing the solute as it is fed to the membrane. The minimum rejection ratio approaches zero as the diameter of the shaft approaches the diameter of the piston. Various shaft and bushing/seal combinations can be employed in a modular design and swapped out in order to provide various recovery ratios appropriate to the solute to be filtered. In this way, a single filtration device can be used in various situations while only replacing small components which can be swapped in the field.

FIG. 1A is a schematic illustration of an example embodiment of the present invention having a piston shaft with a first cross-sectional area. The ratio of the piston diameter to the piston shaft diameter will influence the recovery ratio as described above. FIG. 1B is a schematic illustration of an example embodiment of the present invention having a piston shaft with a second cross-sectional area. Since the second cross-sectional area is different than the first cross-sectional area (in FIG. 1A), the recovery ratio of the example of FIG. 1B will be different from that of the example of FIG. 1A, and the pistons and shafts can be selected so that their relative cross-sectional areas provide the desired recovery ratios.

In an example embodiment, the design incorporates one or more concentric volumes or shells which can be selectively coupled to the shaft to increase the effective shaft volume. These volumes or shells can either remain uncoupled, allowing the shaft to operate with its minimum volume, or can be coupled, either individually or multiply to increase the effective volume or diameter of the shaft. The volumes or shells can be coupled in various manners, including as example mechanically coupled by means of a locking pin or clip, or another mechanical or electro-mechanical engaging mechanism.

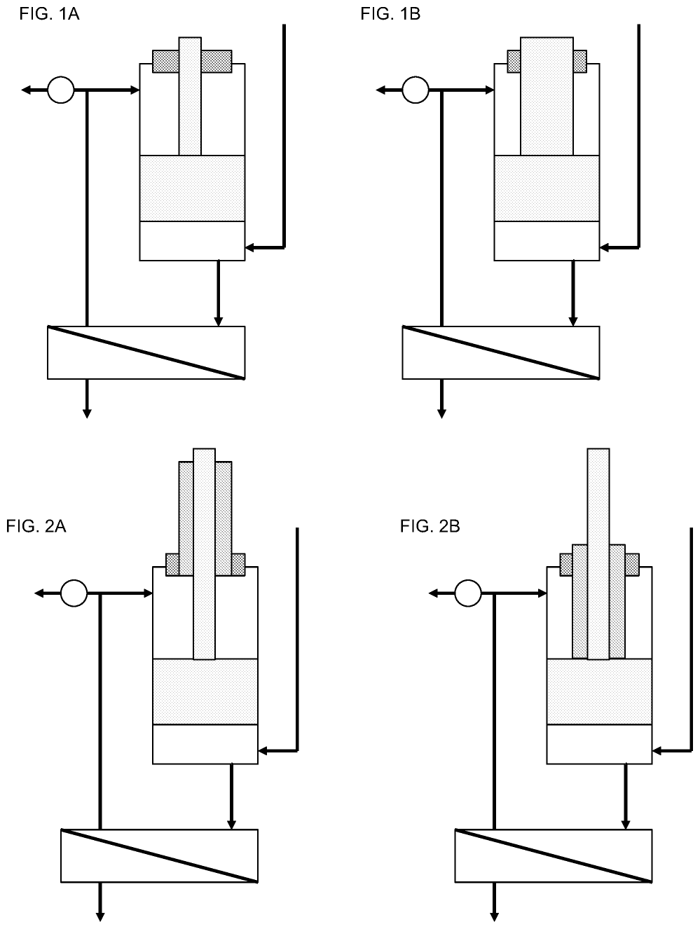

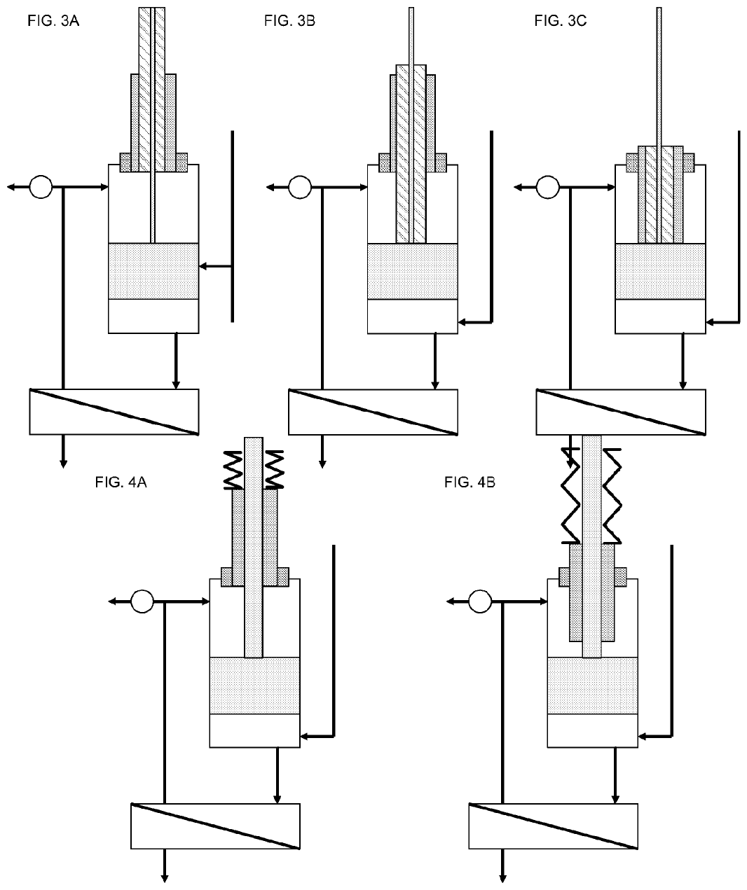

FIG. 2A is a schematic illustration of an example embodiment of the present invention having a piston shaft with a first cross-sectional area, and a sleeve through which the piston moves. The piston shaft moves with the piston, while the sleeve remains in a position such that it does not affect the area of the piston exposed to pressure on the top surface in the figure, or the back side of the piston relative to the pumping volume (in the figure, the concentric circle area between the outside diameter of the piston and outside diameter of the shaft). The recovery ratio is thus determined by the relative cross-sectional areas of the piston and the shaft.

FIG. 2B is a schematic illustration of an example embodiment of the present invention having a piston shaft with a first cross-sectional area and a sleeve that moves with the piston shaft. The sleeve of the example in FIG. 2B reduces the cross-sectional area of the piston that is exposed to pressure from the top or back side of the piston, and thus the recovery ratio is determined by the relative cross-sectional areas of the piston and the shaft+sleeve. The piston, shaft, and sleeve can be selected so that the piston/shaft combination provides a recovery ratio desirable for a first operating environment, and the piston/shaft+sleeve combination provides a recovery ratio desirable for a second operating environment.

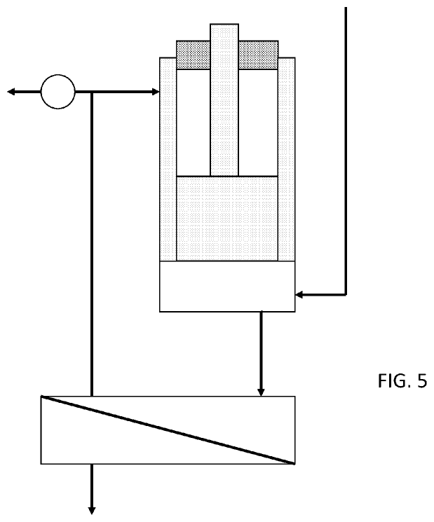

FIG. 3A is a schematic illustration of an example embodiment of the present invention having a piston shaft with a first cross-sectional area, and first and second sleeves through which the piston moves. The piston shaft moves with the piston, while the sleeves remain in a position such that neither sleeve affects the area of the piston exposed to pressure on the top surface. The recovery ratio is thus determined by the relative cross-sectional areas of the piston and the shaft.

FIG. 3B is a schematic illustration of an example embodiment of the present invention having a piston shaft with a first cross-sectional area, and a first sleeve that moves with the piston, and a second sleeve through which the piston and first sleeve move. The first sleeve of the example in FIG. 3B reduces the cross-sectional area of the piston that is exposed to pressure from the top, and thus the recovery ratio is determined by the relative cross-sectional areas of the piston and the shaft+first sleeve

FIG. 3C is a schematic illustration of an example embodiment of the present invention having a piston shaft with a first cross-sectional area, and first and second sleeves that move with the piston. The first and second sleeves of the example in FIG. 3C reduce the cross-sectional area of the piston that is exposed to pressure from the top, and thus the recovery ratio is determined by the relative cross-sectional areas of the piston and the shaft+first sleeve+second sleeve. The piston, shaft, and sleeves can be selected so that the piston/shaft combination provides a recovery ratio desirable for a first operating environment, and the piston/shaft+first sleeve combination provides a recovery ratio desirable for a second operating environment, and the piston/shaft+first sleeve+second sleeve combination provides a recovery ratio desirable for a third operating environment. Other example embodiments can incorporate other numbers of sleeves, selectively coupled to provide a variety of recovery ratios.

In an example embodiment, the volumes or shells can also be coupled by spring or pressure, actuated by pressure differential such that when high pressure is applied to the back of the piston, the spring or pressurization keeps the volumes in place and the effective piston diameter is minimized giving a high rejection ratio, as in the case of seawater filtration. When low pressure exists on the back side of the piston during operation, as in the case of low solute concentration fluid such as fresh water, the volumes or sleeves can extend and cause the rejection ratio to decrease, causing more of the solute to be forced through the membrane and increasing the output for the same input energy. In one embodiment, the piston may not rise fully in the piston cylinder so that the applied pressure would be experienced by the volumes or shells to allow for the pressure actuation.

FIG. 4A is a schematic illustration of an example embodiment of the present invention having a piston shaft with a first cross-sectional area, and a sleeve through which the piston moves. FIG. 4B is a schematic illustration of an example embodiment of the present invention having a piston shaft with a first cross-sectional area and a sleeve that moves with the piston shaft.

In each embodiment, it should be noted that the pressure relief valve can also be adjusted or replaced to compensate and allow maximum energy recovery for each configuration. It is noted that any type of movable sections that can be coupled to the motion of the shaft can be used to occupy volume on the back side of the piston to modify the recovery ratio, and that the design of these is not limited to movable concentric shells or volumes, e.g. a square shaft which couples to the movement of the shaft and is sealed within the piston cylinder can be used to change the relative volumes while not being concentric or even in contact with the shaft; or two parallel shafts can be used, with either one or both shafts in operation; and this concept can be implemented in multiple additional designs.

FIG. 5 is a schematic illustration of an example embodiment. A piston slides within a chamber formed by inner side walls. The inner side walls slidably mount within outer side walls. If the inner side walls are fixed to the outer side walls, then the effective diameter of the piston in the lower chamber in the figure is just the diameter of the face of the piston. If the inner side walls are fixed to the piston or piston shaft, then the effective diameter of the piston in the lower chamber is the diameter of the piston increased by the thickness of the inner side walls, changing the force on the piston in the lower chamber correspondingly.

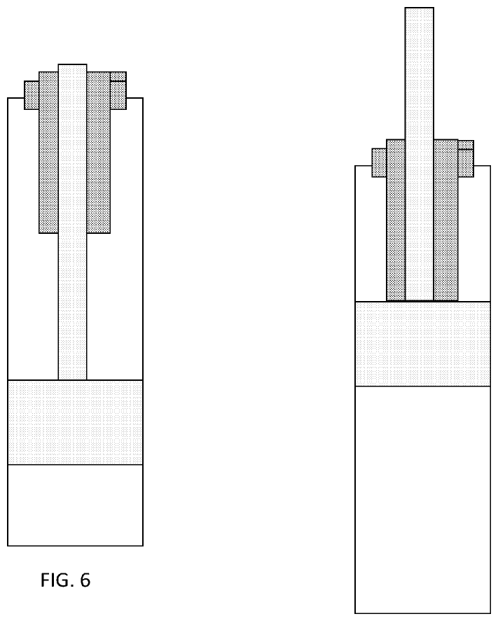

FIG. 6 is a schematic illustration of an example embodiment. A piston is moved by a piston shaft within a chamber. A sleeve moves with the piston when the piston is in the upper region of a range of motion (as shown in the configuration on the right in the figure). The effective diameter of the piston in the upper chamber is reduced by the sleeve when the piston is in the upper portion of its range of motion. When the piston is in a lower portion of its range of motion (as shown in the configuration on the left in the figure), the sleeve is retained and prevented from moving with the piston, so the effective diameter of the piston is not reduced by the sleeve when moving in the lower portion of the piston's range of motion. The recovery ratio can thus be selected by selecting which portion of the piston's range of motion to operate.

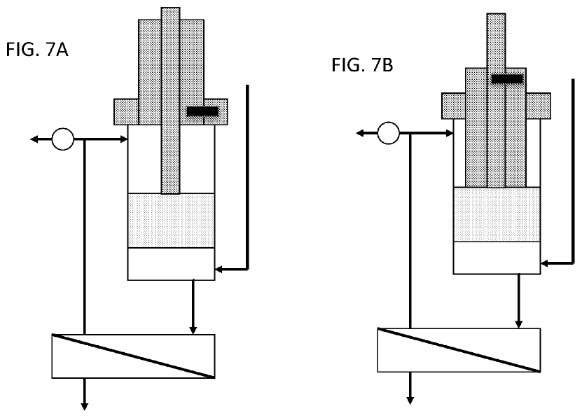

In embodiments where a sleeve is coupled to a piston shaft, a bushing, or another sleeve, various mechanisms of mechanical engagement known in the art can be suitable. FIG. 7A and FIG. 7B are schematic illustrations of an example embodiment illustrating coupling of a sleeve to a bushing (FIG. 7A) or a piston shaft (FIG. 7B). In FIG. 7A, the sleeve is pinned to the housing and bushing. The piston slides in the sleeve. This example provides low permeate recovery and high energy recovery, for a high TDS application. In FIG. 7B, the sleeve is pinned to the piston shaft and the sleeve slides in the housing and bushing. The piston and shaft slide together. This example provides high permeate recovery and low energy recovery, for a low TDS application. A keyed twist of the shaft/sleeve/bushing relative to one another can be suitable for selectively coupling the elements, as can a threaded arrangement or separate pins (one to couple/uncouple the shaft to the sleeve and another to couple/uncouple the sleeve to the bushing).

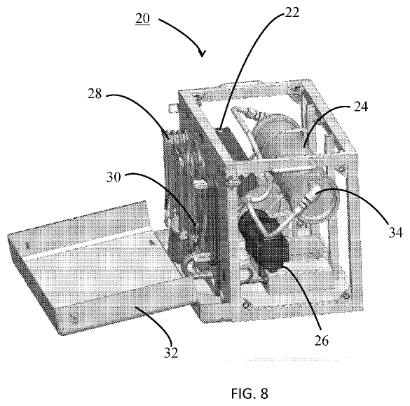

FIG. 8 is an illustration of an example embodiment of a treatment system incorporating a pump as described above. In a package sized for easy portability, this example system can deliver 300 gallons of potable water per day in a system size of approximately 24 inches×16 inches×12 inches, and weighing less than 80 pounds. System 20 can be housed in a frame for easy transport. Pump head 22 comprises a pump as described above. Pump head 22 can be constructed of (as examples) stainless steel, titanium, or suitable high strength injection molded plastic for glass reinforced plastics. The piston and shaft can be constructed of similar materials and seals made of appropriate elastomers such as Viton, Buna N, or other suitable materials. The housing frame can be constructed of steel, aluminum, titanium, or composite high strength plastics. Pump head 22 is connected via fluid lines 34 to reverse osmosis element housing 24. Reverse osmosis element housing may be constructed of plastic, stainless, titanium, or other suitable materials. The reverse osmosis spiral wound membrane element can be a conventional element as commonly used in the industry, or can be a spiral wound membrane element made with printed feed spacers as manufactured by Aqua Membranes LLC, Albuquerque, N. Mex. Motor drive 26 provides reciprocating power to pump head 22. Supply and discharge hoses 28 can be stored on hose storage mounting devices. Power supply cord 30 can also be stored in mounting brackets. In the storage configuration, storage cover 32 closes to conceal and protect supply and discharge hoses 28 and power cord 30 for transport and storage. Storage cover 32 can be constructed of an appropriate sheet metal, high impact plastic, or fiberglass material suitable for the operating environment and light weight construction.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

1. A reciprocating piston pump for use in a reverse osmosis system, comprising a chamber, a piston slidable within the chamber, and a first element that can be configured in a first configuration wherein the piston has a first cross-sectional area receiving pressure from within the chamber, and second configuration wherein the piston has a second cross-sectional area receiving pressure from within the chamber, where the second cross-sectional area is different than the first cross-sectional area.

2. A pump as in claim 1, further comprising a shaft that moves with the piston, and wherein the first element comprises a sleeve concentric with the shaft, and in the first configuration the shaft slides through the sleeve and the sleeve is not in contact with the piston, and in the second configuration the sleeve slides with the shaft and the sleeve is in contact with the piston.

3. A pump as in claim 1, further comprising a second element that can be configured in a first configuration wherein the piston has a third cross-sectional area receiving pressure from within the chamber, and second configuration wherein the piston has a fourth cross-sectional area receiving pressure from within the chamber, where the first, second, and fourth cross-sectional areas are different from each other.

4. A reciprocating piston pump as in claim 1, comprising a shaft mounted with the chamber and the piston such that the shaft can slide into and out of the chamber, and such that such sliding motion of the shaft corresponds to sliding motion of the piston within the chamber, wherein the shaft has a cross-sectional area that is configurable to at least two distinct values.

5. A reciprocating piston pump for use in a reverse osmosis system, comprising a chamber element defining an interior volume; a first piston subsystem configured to slidably engage the interior volume and separate it into first and second volumes, wherein the first piston subsystem presents a first cross-sectional area to the first volume; and a second piston subsystem configured to slidably engage the interior volume and separate it into first and second volumes, wherein the second piston subsystem presents a second cross-sectional area to the first volume; wherein the first cross-sectional area is different than the second cross-sectional area.

6. A reciprocating piston pump as in claim 5, wherein the first piston subsystem comprises a first piston, a first shaft, and a first sealing member, wherein the first sealing member is configured to sealingly mount with the chamber element, the first piston is configured to slidably engage the interior volume, and together with the first sealing member define the first volume, wherein the first shaft is configured to slide through the first sealing member and to engage the piston such that sliding motion of the first shaft imparts sliding motion of the piston relative to the chamber element, wherein the first shaft has a first shaft cross-sectional area; and wherein the second piston system comprises a second piston, a second shaft, and a second sealing member, wherein the second sealing member is configured to sealingly mount with the chamber element, the second piston is configured to slidably engage the interior volume, and together with the second sealing member define the first volume, wherein the second shaft is configured to slide through the second sealing member and to engage the piston such that sliding motion of the second shaft imparts sliding motion of the piston relative to the chamber element, wherein the second shaft has a second shaft cross-sectional area; wherein the first shaft cross-sectional area is different than the second shaft cross-sectional area.

7. A reciprocating piston pump as in claim 6, wherein the first piston and the second piston comprise a single piston, used as the first piston in the first piston subsystem and as the second piston in the second piston subsystem.

8. A reciprocating piston pump as in claim 6, wherein the first sealing member and the second sealing member comprise a single sealing member, used as the first sealing member in the first piston subsystem and as the second sealing member in the second piston subsystem.

9. A reciprocating piston pump as in claim 1, wherein the piston divides the chamber into a pumping chamber portion and a driving chamber portion, and further comprising a driving chamber seal mounted with the chamber and sealing the driving chamber portion; and wherein the first element comprises a sleeve mounted extending through the driving chamber seal; and further comprising a shaft extending from the piston through sleeve; wherein in the first configuration the sleeve is engaged with the chamber, the driving chamber seal, or both, and the shaft moves within the sleeve as the piston slides within the chamber, and wherein in the second configuration the sleeve is engaged with the piston, the shaft, or both, and the sleeve moves with the piston as the piston slides within the chamber.

10. A system for treatment of water, comprising a frame, a reciprocating piston pump as in claim 1 mounted with the frame; a reverse osmosis element in fluid communication with the pump; and a motor drive configured to drive the pump.

11. (canceled)
